(19) United States
(12) Patent Application Publication
(10) Pub. No.: US 2019/0286856 A1
(43) Pub. Date: Sep. 19, 2019

(54) CARD READER AND METHOD OF CONTROLLING CARD READER

(71) Applicant: NIDEC SANKYO CORPORATION, Nagano (JP)

(72) Inventors: Toshiro SHIOMI, Nagano (JP); Tsutomu ORII, Nagano (JP)

(21) Appl. No.: 16/337,494

(22) PCT Filed: Sep. 22, 2017
(86) PCT No.: PCT/JP2017/034185

§ 371 Date: Mar. 28, 2019

(30) Foreign Application Priority Data
Sep. 30, 2016 (JP) 2016-193305

(51) Int. Cl. G06K 7/08

(52) U.S. Cl. CPC G06K 7/087

(57) ABSTRACT

A card reader may include a card slot a card path extending from the card slot and a magnetic head structured to reproduce information in the magnetic recording layer of the card. The card reader may include a first detector structured to detect the card; a second detector structured to detect an edge of the card on an inserting direction side reaching an innermost side of the card path; and a controller. The controller may be configured to continue processing the card when the first detector does not detect the card being inserted to the card slot and the magnetic head detects a magnetic signal or when the first detector does not detect the card being inserted to the card slot and the second detector detects the card reaching the innermost side.

### CROSS REFERENCE TO RELATED APPLICATIONS

This is the U.S. national stage of application No. PCT/JP2017/034185, filed on Sep. 22, 2017. Priority under 35 U.S.C. §119(a) and 35 U.S.C. § 365(b) is claimed from Japanese Application No. 2016-193305, filed Sep. 30, 2016; the disclosures of which are incorporated herein by reference.

### TECHNICAL FIELD

At least an embodiment of the present invention relates to a card reader and a method of controlling a card reader.

### BACKGROUND

A card reader that processes a card having a magnetic recording layer in which information is recorded includes a card slot, a card path extending from the card slot, and a magnetic head reproducing the information on the card inserted to the card slot. The card reader further includes a first detector detecting the card being inserted to the card slot and a second detector detecting the edge of the card adjacent to the insertion direction reaching the innermost side of the card path. When the second detector detects the card reaching the inner side after the first detector detects the insertion of the card, the magnetic head processes the detected information (for example, refer to PTL 1). When the first detector detects no card after the card is processed and the card is manually pulled out, it can be determined that the card is not left behind.

### PATENT LITERATURE

[Patent Literature 1] PTL 1: Japanese Unexamined Patent Application Publication No. 2011-113209

However, with the configuration according to PTL 1, if the insertion of the card properly inserted to the card slot is undetected due to a defect of the first detector, the processing of the card is discontinued, thereby causing inconvenience.

Considering the problem described above, at least an embodiment of the present invention provides a card reader that can continue processing a card even when insertion of the card is undetected due to a defect of a detector detecting the insertion of the card to a card slot.

### SUMMARY

To solve the issues described above, at least an embodiment of the present invention provides a card reader including a card slot through which a card is inserted, the card including a magnetic recording layer in which information is recorded; a card path extending from the card slot; and a magnetic head at least reproducing information in the magnetic recording layer of the card inserted to the card slot, the card being manually inserted to or ejected from the card slot, wherein, the card reader further includes a first detector detecting the card being inserted to the card slot; a second detector detecting an edge of the card on an inserting direction side reaching an innermost side of the card path; and a controller, and the controller continues processing the card when the first detector does not detect the card being inserted to the card slot and the magnetic head detects a magnetic signal or when the first detector does not detect the card being inserted to the card slot and the second detector detects the card reaching the innermost side.

With the card reader according to at least an embodiment of the present invention, even when the first detector does not detect the card being inserted to the card slot, processing of the card continues when the magnetic head detects a magnetic signal or when the second detector detects the reaching of the card. Thus, the processing of the card can continue even when the insertion of the card is undetected due to a defect of the first detector after appropriately inserting the card to the card slot.

At least an embodiment of the present invention provides a method of controlling a card reader, the card reader including a card slot through which a card is inserted, the card including a magnetic recording layer in which information is recorded; a card path extending from the card slot; and a magnetic head at least reproducing information in the magnetic recording layer of the card inserted to the card slot, the card being manually inserted to or ejected from the card slot, the method including a first determining step including determining whether a first detector detecting the card being inserted to the card slot detects the card being inserted; and a second determining step including determining whether a second detector detecting an edge of the card on an inserting direction side reaching an innermost side of the card path detects the card reaching the innermost side, wherein processing of the card continues when the second detector does not detect the card being inserted in the first determining step and the magnetic head detects a magnetic signal or when the second detector does not detect the card being inserted in the first determining step and the second detector detects the card reaching the innermost side in the second determining step.

With the method of controlling a card reader according to at least an embodiment of the present invention, even when the first detector does not detect the card being inserted to the card slot, processing of the card continues when the magnetic head detects a magnetic signal or when the second detector detects the reaching of the card. Thus, the processing of the card can continue even when the insertion of the card is undetected due to a defect of the first detector after appropriately inserting the card to the card slot.

In the card reader and the method of controlling a card reader according to an embodiment of the present invention, the first detector may include a movable member for sensing displaced in contact with the card inserted to the card slot and being displaced; and an optical sensor detecting the displacement of the movable member for sensing. With such an embodiment, wearing, etc. in the movable member for sensing may cause the card that is appropriately inserted to the card slot to be prone to false detection of not being inserted. However, according to at least an embodiment of the present invention, even when such false detection occurs, processing of the card can continue.

In the card reader and the method of controlling a card reader according to an embodiment of the present invention, an IC terminal may be disposed on one face of the card, and the card reader may further include an IC contact coming into contact with the IC terminal when the edge of the card reaches the innermost side of the card path.

The card reader according to at least an embodiment of the present invention may further include a storage unit storing at least one of the number of times the magnetic head detected a magnetic signal when the first detector did not detect the card being inserted to the card slot, the number of times the second detector detected the card reaching the innermost side when the first detector did not detect the card being inserted to the card slot, and the number of times the magnetic head detected a magnetic signal or the second detector detected the card reaching the innermost side when the first detector did not detect the card being inserted to the card slot. According to such an embodiment, notification about a defect in the first detector can be provided.

The method of controlling a card reader according to at least an embodiment of the present invention may further include storing in a storage unit at least one of the number of times the magnetic head detected a magnetic signal when the first detector did not detect the card being inserted to the card slot, the number of times the second detector detected the card reaching the innermost side when the first detector did not detect the card being inserted to the card slot, and the number of times the magnetic head detected a magnetic signal or the second detector detected the card reaching the innermost side when the first detector did not detect the card being inserted to the card slot. According to such an embodiment, notification about a defect in the first detector or a defect of the card reader in the first detecting step can be provided.

With the card reader and the method of controlling according to at least an embodiment of the present invention, even when the first detector does not detect the card inserted to the card slot, the processing of the card is continued when the magnetic head detects a magnetic signal or when the second detector detects the card reaching the innermost side. Thus, the processing of the card can be continued even when the insertion of the card is undetected due to a defect of the first detector after the card is appropriately inserted to the card slot.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic view of an example planar configuration of a card reader according to at least an embodiment of the present invention.

FIG. 2 is a block diagram illustrating a configuration associated with a control unit of the card reader illustrated in FIG. 1.

FIG. 3 is a flow chart illustrating an example control flow for the insertion of a card to the card reader illustrated in FIG. 1.

### DETAILED DESCRIPTION

At least an embodiment of the present invention will now be described with reference to the drawings.

### Overall Configuration of Card Reader 1

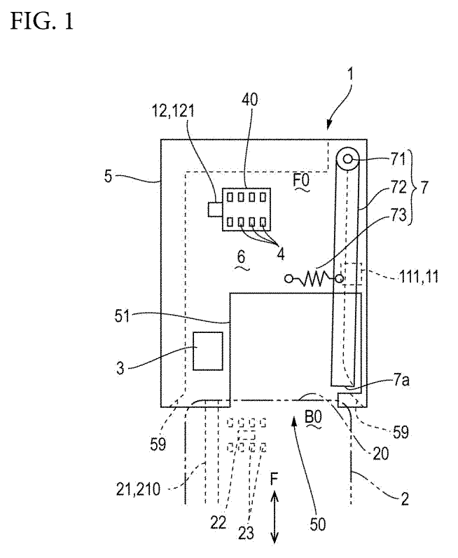

FIG. 1 is a schematic view of an example planar configuration of a card reader 1 according to at least an embodiment of the present invention. The card reader 1 illustrated in FIG. 1 includes a frame 5 having a card slot 50 and a card inlet/outlet recess 51 depressed in the inserting direction F of a card 2. With the card reader 1, the card 2 is manually inserted to the card slot 50 in the recess 51 until the card reaches a card stop position. The card 2 is then manually pulled out. The card reader 1 has an internal card path 6 connected to the card slot 50.

The card reader 1 includes guides 59 that guide the card 2 on the two sides of the frame 5 when the card 2 is inserted and a magnetic head 3 disposed on a side of the recess 51. The card reader 1 further includes an urging member 7 disposed adjacent to the recess 51 on a side opposite to the magnetic head 3. The urging member 7 urges the card 2 toward the guide 59 adjacent to the magnetic head 3. In the urging member 7, the end portion 7a on the ejection side B of the card 2 resides closer to the innermost side FO (inserting direction side F) than the card slot 50. Thus, when the card 2 is inserted, the two sides of the card 2 are guided by the guides 59. Thus, the direction of insertion of the card 2 can be readily and appropriately determined.

The urging member 7 includes a lever 72 rotatably supported on a support shaft 71 near the completely inserted position of the card 2 and an urging unit 73 urging the lever 72 toward the card 2. The urging unit 73 is, for example, a helical extension spring. The end portion 7a of the urging member 7 disposed on the front side B0 (ejecting direction side B) is disposed between the card slot 50 and the magnetic head 3. The card 2 is detected by the magnetic head 3 after the card 2 is inserted and comes into contact with the urging member 7. Thus, the moving rate of the card 2 during detection by the magnetic head 3 is substantially constant.

The card 2 is, for example, a rectangular vinyl chloride card having a thickness of approximately 0.7 to 0.8 mm, a polyethylene terephthalate (PET) card having a thickness of approximately 0.18 to 0.36 mm, or a paper card. One face of the card 2 is provided with a magnetic strip 210 storing magnetic information as a magnetic recording layer 21. One of the two faces of the card 2 is provided with a fixed IC chip 22. The IC chip 22 is connected to IC terminals 23. Thus, the card reader 1 includes IC contacts 4 that come into contact with the IC terminals 23 when an edge 20 of the card 2 on the inserting direction side F reaches the innermost side FO of the card path 6.

The IC contacts 4 are fixed to an IC contact block 40 disposed on the innermost side FO (inserting direction side F) of the card path 6. The IC contact block 40 is urged by an urging member (not illustrated). Thus, when the IC contact block 40 is pushed by the edge 20 of the card 2, the IC contacts 4 shift closer to the card 2 and come into contact with the IC terminals 23. When the card 2 is pulled out, the IC contact block 40 shifts by the urging force of the urging member. As a result, the IC contacts 4 shift away from the card 2 and detach from the IC terminals 23.

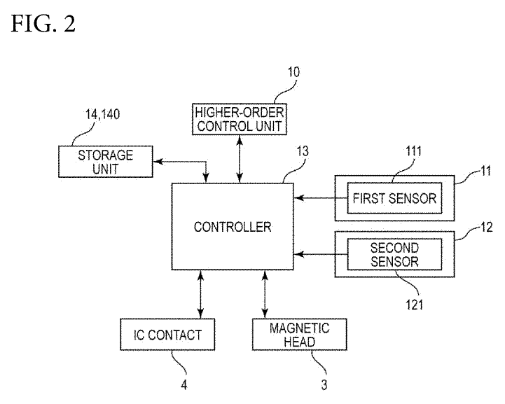

The card reader 1 having such a configuration includes a first detecting mechanism 11 (front detecting mechanism) that detects the card 2 being inserted to the card slot 50, a second detecting mechanism 12 (rear detecting mechanism) that detects the card 2 reaching the innermost side FO of the card path 6, and a control unit 13 (see FIG. 2) that controls the card reader 1.

### Configuration of First Detecting Mechanism 11

The first detecting mechanism 11 uses the urging member 7 to constitute a first detector that detects the card 2 being inserted to the card slot 50. When the first detecting mechanism 11 detects no card 2 after the processing of the card 2 is completed and the card 2 is manually pulled out, it is determined that the card 2 is not left behind, and process proceeds to the next operation. In contrast, when the first detecting mechanism 11 detects the card 2, it is determined that the card 2 has been left behind, and the card reader 1 provides notification about the left behind card 2.

The first detecting mechanism 11 is a mechanical detector that monitors the displacement of the lever 72 pushed by the card 2. Thus, the lever 72 is used as a movable member for sensing. The first detecting mechanism 11 includes a first sensor 111. The first sensor 111 is an optical sensor that detects the displacement of the lever 72 and includes a light-emitting device and a light-receiving device (not illustrated).

For example, when the card 2 is not inserted to the card slot 50, a light shield provided on the lever 72 is not disposed between the light-emitting device and the light-receiving device of the first sensor 111 of the first detecting mechanism 11. In contrast, when the card 2 is inserted to the card slot 50 and the lever 72 is displaced, the light shield of the lever 72 is disposed between the light-emitting device and the light-receiving device of the first sensor 111 to shield the devices from each other. Thus, the first detecting mechanism 11 detects whether the card 2 is inserted to the card slot 50 on the basis of the detected result by the first sensor 111. When the card 2 is inserted to the card slot 50, the magnetic head 3 receives magnetic signals regardless of the detected result of the first detecting mechanism 11 because the card 2 slides relative to the magnetic head 3.

### Configuration of Second Detecting Mechanism 12

The second detecting mechanism 12 constitutes a second detector that detects the edge 20 of the card 2 reaching the innermost side FO of the card path 6. In this embodiment, the second detecting mechanism 12 is a mechanical detector that monitors the displacement of the IC contact block 40 pushed by the edge 20 of the card 2 and includes a second sensor 121. The second sensor 121 is an optical sensor that detects the displacement of the IC contact block 40 and includes a light-emitting device and a light-receiving device (not illustrated).

When the edge 20 of the card 2 has not yet reached the innermost side F0 of the card path 6, a light shield that is displaced together with the IC contact block 40 is not disposed between the light-emitting device and the light-receiving device of the second sensor 121 of the second detecting mechanism 12. When the edge 20 of the card 2 reaches the innermost side F0 of the card path 6 and the IC contact block 40 is displaced, the light shield of the IC contact block 40 is disposed between the light-emitting device and the light-receiving device of the second sensor 121 to shield the devices from each other. Thus, the second detecting mechanism 12 can detect whether the edge 20 of the card 2 has reached the innermost side F0 of the card path 6 on the basis of the detected result by the second sensor 121.

### Configuration of Control Unit 13

FIG. 2 is a block diagram illustrating a configuration associated with the control unit 13 of the card reader 1 in FIG. 1. As illustrated in FIG. 2, the card reader 1 includes the control unit 13 as a controller for controlling the card reader 1. The control unit 13 is connected to the magnetic head 3 and the IC contacts 4. The control unit 13 is also connected to the first sensor 111 and the second sensor 121 and receives signals output from the first sensor 111 and signals output from the second sensor 121. The control unit 13 is also connected to a higher-order control unit 10 controlling a high-order apparatus in which the card reader 1 is installed. The control unit 13 is also connected to a storage unit 14 that stores the number of times a fallback operation is performed, which is described below. The storage unit 14 includes a non-volatile memory 140.

### Basic Normal Operation of Card Reader 1

With reference to FIG. 2, the control unit 13 periodically monitors the output from the first sensor 111 of the first detecting mechanism 11 and determines whether the first detecting mechanism 11 has detected the card 2 being inserted to the card slot 50. This process corresponds to the first determining step according to at least an embodiment of the present invention. The control unit 13 also periodically monitors the output from the second sensor 121 of the second detecting mechanism 12 and determines whether the second detecting mechanism 12 has detected the card 2 reaching the innermost side of the card path 6. This process corresponds to the second determining step according to at least an embodiment of the present invention.

In the first detecting mechanism 11, if the first detecting mechanism 11 is free of defects, the lever 72 is displaced by the card 2 inserted to the card slot 50. Thus, the control unit 13 determines that the first detecting mechanism 11 has detected the card 2 inserted to the card slot 50 on the basis of the output from the first sensor 111. While the card 2 slides relative to the magnetic head 3 as the card 2 is inserted, the control unit 13 controls the magnetic head 3 to reproduce the information in the magnetic recording layer 21 of the card 2.

When the card 2 is inserted to the innermost side F0, in the second detecting mechanism 12, the IC contact block 40 is displaced. Thus, the control unit 13 determines that the second detecting mechanism 12 has detected the card 2 reaching the innermost side FO of the card path 6 on the basis of the output from the second sensor 121. At this time, while the IC contacts 4 come into contact with the IC terminals 23, the control unit 13 establishes communication with the IC chip 22 of the card 2 via the IC contacts 4.

### Fallback Operation of Card Reader 1 During Defect

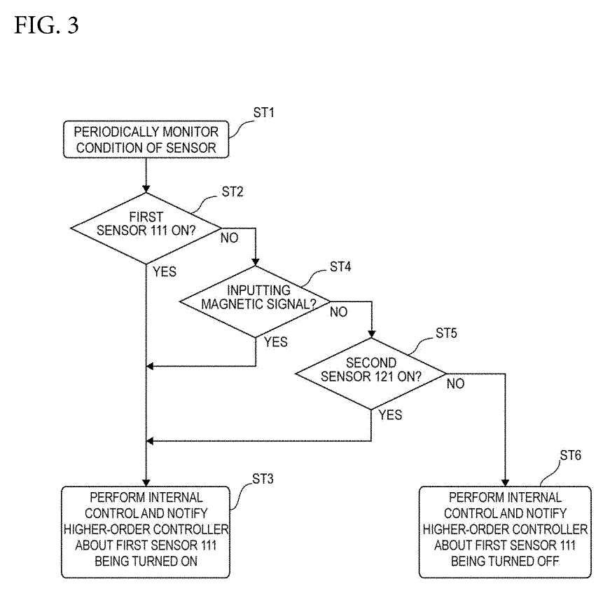

FIG. 3 is a flow chart illustrating an example a fallback operation of the card reader 1 illustrated in FIG. 1. In the card reader 1 according to this embodiment, the fallback operation illustrated in FIG. 3 is carried out when the first detecting mechanism 11 has a defect.

In step ST1, the control unit 13 periodically monitors the output from the first sensor 111 of the first detecting mechanism 11 and the output from the second sensor 121 of the second detecting mechanism 12. In step ST2 (the first determining step), the control unit 13 determines whether the first detecting mechanism 11 has detected the card 2 being inserted to the card slot 50.

In the determination process in step ST2, if the control unit 13 determines that the first detecting mechanism 11 has detected the insertion of the card 2 (the first sensor 111 is turned on), the control unit 13 determines the insertion of the card 2 to the card slot 50 and, in step ST3, continues the processing on the card 2, such as internal control including reproduction of the information in the magnetic recording layer 21 of the card 2 by the magnetic head 3 and communication between the IC contacts 4 and the IC chip 22 of the card 2 and notification of the content of the internal control to a higher-order controller.

In the determination process in step ST2 (the first determining step), if the control unit 13 determines that the first detecting mechanism 11 detected no insertion of the card 2 (the first sensor 111 is turned off), the control unit 13 determines whether a magnetic signal is input to the magnetic head 3 in step ST4.

In the determination process in step ST4, if the control unit 13 determines that a magnetic signal is input to the magnetic head 3, the control unit 13 determines that the first detecting mechanism 11 has detected the insertion of the card 2 to the card slot 50 in step ST3, and continues the processing on the card 2, such as internal control including reproduction of the information in the magnetic recording layer 21 of the card 2 by the magnetic head 3 and communication between the IC contacts 4 and the IC chip 22 of the card 2 and notification of the content of the internal control to a higher-order controller.

In step ST4, if the control unit 13 does not determine that a magnetic signal is input to magnetic head 3, the control unit 13 determines whether the second detecting mechanism 12 has detected the card 2 reaching the innermost side FO of the card path 6 in step ST5 (the second determining step).

In the determination process in step ST5, if the control unit 13 determines that the second detecting mechanism 12 has detected the card 2 reaching the innermost side FO of the card path 6 (the second sensor 121 is turned on), the control unit 13 determines that the first detecting mechanism 11 has detected the card 2 inserted to the card slot 50 in step ST3, continues the processing on the card 2, such as internal control including reproduction of the information in the magnetic recording layer 21 of the card 2 by the magnetic head 3 and communication between the IC contacts 4 and the IC chip 22 of the card 2 and notification of the content of the internal control to a higher-order controller.

In the determination process in step ST5, if the control unit 13 does not determine that the second detecting mechanism 12 detected the card 2 reaching the innermost side FO of the card path 6 (the second sensor 121 is turned off), the control unit 13 does not carry out internal control, such as reproduction of information in the magnetic recording layer 21 of the card 2, and notifies the higher-order controller about this in step ST6.

While repeating the above-described operation, the control unit 13 stores in the storage unit 14 the number of times the magnetic head 3 detected a magnetic signal or the second detecting mechanism 12 detected the card 2 reaching the innermost side, when the first detecting mechanism 11 does not detect the card 2 inserted to the card slot 50 (see FIG. 2).

### Main Advantageous Effects of This Embodiment

As described above, in this embodiment, even when the first detecting mechanism 11 does not detect the card 2 inserted to the card slot 50, the processing of the card 2 is continued when the magnetic head 3 detects a magnetic signal or when the second detecting mechanism 12 detects the card 2 reaching the innermost side F0. Thus, the processing of the card 2 can be continued even when the insertion of the card 2 is undetected after appropriately inserting the card 2 to the card slot 50 due to defects, such as wear of the lever 72 of the first detecting mechanism 11 or disconnection of the first sensor 111.

In this embodiment, the first detecting mechanism 11 is a mechanical detector using the lever 72, which comes into contact with the card 2. Thus, the optical detector that detects the card 2 as a result of the card 2 being disposed between the light-emitting device and the light-receiving device to shield the devices from each other can appropriately detect the card 2 by the first detecting mechanism 11 even when the card 2 is a transmissive card, a card having rounded corners, or a non-standard card which are difficult to detect. Since the lever 72, which comes into contact with the card 2, wears due to contact with the card 2, the first detecting mechanism 11 is prone to defects. In this embodiment, an appropriate fallback operation can be carried out in response to a defect of the first detecting mechanism 11, as described above.

The control unit 13 stores in the storage unit 14 the number of times the magnetic head 3 detected a magnetic signal or the second detecting mechanism 12 detected the card 2 reaching the innermost side F0, when the first detecting mechanism 11 does not detect the card 2 inserted to the card slot 50. Thus, when the number of times stored in the storage unit 14, for example, reaches a predetermined number, it can be determined that the first detecting mechanism 11 is highly likely to have a detect. Note that the control unit 13 may store in the storage unit 14 the number of times the magnetic head 3 detected a magnetic signal or the second detecting mechanism 12 detected the card 2 reaching the innermost side, when the first detecting mechanism 11 does not detect the card 2 inserted to the card slot 50.

### Other Embodiments

Although at least an embodiment of the present invention has been described based on specific embodiments, the present invention is not limited to above embodiment and various modifications of the embodiments may be made without departing from the scope of the present invention.

For example, in the above-described embodiment, internal control, such as reproducing information in the magnetic recording layer 21 of the card 2 by the magnetic head 3, is executed and the content of the internal control is notified to the higher-order controller when it is determined that the card 2 is inserted to the card slot 50. Alternatively, at least an embodiment of the present invention may be applied to a configuration in which the result detected by the IC contacts 4 is notified to the high-order controller when it is determined that the card 2 is inserted to the card slot 50.

In the above-described embodiment, the first detecting mechanism 11 and the second detecting mechanism 12 are mechanical detectors. Alternatively, at least one of the first detecting mechanism 11 and the second detecting mechanism 12 may be an optical detector that detects the card 2 when the card 2 is disposed between a light-emitting device and a light-receiving device to shield the devices from each other. In the above-described embodiment, the first detecting mechanism 11 and the second detecting mechanism 12 are detectors using optical sensors. Alternatively, at least one of the first detecting mechanism 11 and the second detecting mechanism 12 may be a mechanical sensor, such as a lever or a microswitch.

In the above-described embodiment, the card reader 1 includes two detecting mechanisms, i.e., the first detecting mechanism 11 and the second detecting mechanism 12, that detect the card 2 being inserted into the card reader 1. Alternatively, the card reader 1 may include three or more detecting mechanisms for detecting the card 2 being inserted into the card reader 1.

In the above-described embodiment, the card reader 1 is installed and used in a predetermined higher-order apparatus. Alternatively, the card reader 1 may be a so-called stand-alone card reader (i.e., a card reader used without being installed in a higher-order apparatus).

In the above-described embodiment, the card 2 is provided with the magnetic recording layer 21 and the IC chip 22. Alternatively, the card 2 may be provided merely with the magnetic recording layer 21 and without the IC chip 22. The card 2 may further include an embedded communication antenna, and characters may be printed on the surface of the card 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A card reader for use with a card comprising a magnetic recording layer in which information is recorded, the card reader comprising:
a card slot through which the card is inserted;
a card path extending from the card slot; and
a magnetic head structured to reproduce information in the magnetic recording layer of the card inserted to the card slot, the card being manually inserted to or ejected from the card slot, wherein,
the card reader further comprises:
a first detector structured to detect the card;
a second detector structured to detect an edge of the card on an inserting direction side reaching an innermost side of the card path; and
a controller, and
the controller is configured to continue processing the card when the first detector does not detect the card being inserted to the card slot and the magnetic head detects a magnetic signal or when the first detector does not detect the card being inserted to the card slot and the second detector detects the card reaching the innermost side.

2. The card reader according to claim 1, wherein the first detector comprises: a movable member structured to be displaced when in contact with the card inserted to the card slot; and an optical sensor detecting the displacement of the movable member.

3. The card reader according to claim 1, further comprising:
an IC contact structured to contact with an IC terminal when the edge of the card reaches the innermost side of the card path,
wherein the IC terminal is disposed on one face of the card.

4. The card reader according to claim 1, further comprising:
a storage unit configured to store at least one of a number of times the magnetic head detected a magnetic signal when the first detector did not detect the card being inserted to the card slot, a number of times the second detector detected the card reaching the innermost side when the first detector did not detect the card being inserted to the card slot, a the number of times the magnetic head detected a magnetic signal or the second detector detected the card reaching the innermost side when the first detector did not detect the card being inserted to the card slot.

5. A method of controlling a card reader, the card reader comprising a card slot through which a card is inserted, the card comprising a magnetic recording layer in which information is recorded; a card path extending from the card slot; and a magnetic head at least reproducing information in the magnetic recording layer of the card inserted to the card slot, the card being manually inserted to or ejected from the card slot, the method comprising:
a first determining step comprising determining whether a first detector detecting the card being inserted to the card slot detects the card being inserted; and
a second determining step comprising determining whether a second detector detecting an edge of the card on an inserting direction side reaching an innermost side of the card path detects the card reaching the innermost side,
wherein processing of the card continues when the magnetic head detects a magnetic signal and the second detector does not detect the card being inserted in the first determining step or when the second detector detects the card reaching the innermost side in the second determining step and the second detector does not detect the card being inserted in the first determining step.

6. The method of controlling a card reader according to claim 5, wherein the first detector comprises: a movable member structured to be displaced when in contact with the card inserted to the card slot; and an optical sensor detecting the displacement of the movable member for sensing.

7. The method of controlling a card reader according to claim 5, wherein,
an IC terminal is disposed on one face of the card, and
the card reader further comprises an IC contact coming into contact with the IC terminal when the edge of the card reaches the innermost side of the card path.

8. The method of controlling a card reader according to claim 5, further comprising:
storing, in a storage unit, at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

9. The card reader according to claim 2, further comprising:
an IC contact structured to contact with an IC terminal when the edge of the card reaches the innermost side of the card path,
wherein the IC terminal is disposed on one face of the card.

10. The card reader according to claim 9, further comprising:
a storage unit structured to store at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

11. The card reader according to claim 2, further comprising:
a storage unit structured to store at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

12. The card reader according to claim 3, further comprising:
a storage unit structured to store at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

13. The method of controlling a card reader according to claim 6, wherein,
an IC terminal is disposed on one face of the card, and
the card reader further comprises an IC contact coming into contact with the IC terminal when the edge of the card reaches the innermost side of the card path.

14. The method of controlling a card reader according to claim 13, further comprising:
storing, in a storage unit, at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

15. The method of controlling a card reader according to claim 6, further comprising:
storing, in a storage unit, at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.

16. The method of controlling a card reader according to claim 7, further comprising:
storing, in a storage unit, at least one of a number of times the magnetic head detected a magnetic signal when the first detector did not detect the card being inserted to the card slot, a number of times the second detector detected the card reaching the innermost side when the first detector did not detect the card being inserted to the card slot, and a number of times the magnetic head detected a magnetic signal or the second detector detected the card reaching the innermost side when the first detector did not detect the card being inserted to the card slot.
